(19) United States
(12) Patent Application Publication
(10) Pub. No.: US 2026/0181314 A1
(43) Pub. Date: Jun. 25, 2026

(54) SPEAKER SYSTEM WITH WAVEGUIDE HORNS HAVING ASYMMETRIC RADIATION STRUCTURE, AND FRONT COVER OF THE SAME

(71) Applicant: LONGINESTENO TECHNOLOGY COMPLEX CORPORATION, New Taipei City (TW)

(72) Inventors: Chao-Lang Wang, New Taipei City (TW); Chien-Cheng Wang, New Taipei City (TW)

(73) Assignee: LONGINESTENO TECHNOLOGY COMPLEX CORPORATION, New Taipei City (TW)

(21) Appl. No.: 19/064,721

(22) Filed: Feb. 27, 2025

(30) Foreign Application Priority Data
Dec. 20, 2024 (TW) 113150074

(51) Int. Cl. H04R 1/34; H04R 1/30

(52) U.S. Cl. CPC H04R 1/345; H04R 1/30

(57) ABSTRACT

A speaker system and its front cover have one or more waveguide horns with one or more asymmetric radiation structures. The speaker system includes a woofer, at least one tweeter, and a speaker system housing whose front side has a first mounting hole mountable with the woofer, and at least one waveguide horn whose throat is mountable with a corresponding tweeter. Each waveguide horn has radiation spreading surfaces. A center of the position where the woofer is located is on a reference plane. Each radiation spreading surface has a centerline having a projected length on the reference plane. Projected lengths of centerlines of the radiation spreading surfaces are different from each other. Through the radiation spreading surfaces’ asymmetric features, it is feasible to effectively adjust the sound tone produced by each tweeter, control the sound spreading mode, and change the areas covered by the directional output of sound.

### CROSS-REFERENCE TO RELATED PATENT APPLICATION

This non-provisional application claims priority to and the benefit of, under 35 U.S.C. § 119(a), Taiwan Patent Application No. 113150074, filed December 20, 2024 in Taiwan. The entire content of the above identified application is incorporated herein by reference.

### FIELD

The present disclosure relates to a speaker system, and more particularly to a speaker system having at least one tweeter and at least one waveguide horn having asymmetric radiation spreading surfaces and at which a corresponding tweeter is located.

### BACKGROUND

Sound has a noticeable directivity feature. One who is listening to a loudspeaker (hereinafter referred to as a speaker for short) feels the greatest acoustic pressure when facing the speaker and on the central axis of the speaker. As the listener moves away from the central axis, the acoustic pressure is gradually lowered, and the greater the angle of deviation from the central axis, the more significant the reduction in acoustic pressure. This phenomenon is known as the off-axis response of sound and is an important factor to be considered when designing a speaker. A waveguide horn is a common acoustic structure in the design of a speaker system and is used mainly to improve the directivity and spreading property of high-frequency sound.

The design of a conventional waveguide horn typically involves using the geometric structure of the waveguide horn to better the directivity and off-axis response of sound. Generally speaking, the basic structure of a waveguide horn includes a throat, a radiation spreading surface, and a horn opening. The radiation spreading surface expands outward gradually from the throat until a relatively large radiation area is formed at the horn opening. The foregoing design structure can concentrate the propagation directions of high-frequency acoustic waves, enhance the directivity of sound, and reduce the dissipation of acoustic energy.

The existing waveguide horn designs, however, generally use a symmetric structure, which imposes considerable limitations when it comes to satisfying complicated acoustic requirements, in particular in an architecture with multiple treble speakers, that is, tweeters; a blind zone can take place in areas where high-frequency sound coverage is anticipated, such that the intended acoustic field, one that is ideal for listening, cannot be achieved. Accordingly, one of the issues to be addressed in the present disclosure is to effectively solve the afore-referenced problems.

### SUMMARY

To stand out in a competitive market, based on the research spirit striving for excellence, and as a result of longtime research and experiments, a speaker system with waveguide horns having asymmetric radiation structures, and the front cover thereof are provided in the present disclosure, so as to win the favor of the market.

Certain aspects of the present disclosure are directed to a speaker system with one or more waveguide horns having one or more asymmetric radiation structures. The speaker system includes a woofer, at least one tweeter, and a speaker system housing. The speaker system housing has a front side divided into an inner region and an outer region. The inner region is provided with a first mounting hole for mounting the woofer therein, the outer region is provided with at least one waveguide horn, and a throat of each of the at least one waveguide horn is provided with a second mounting hole for mounting a corresponding one of the at least one tweeter therein. Each of the at least one waveguide horn has a plurality of radiation spreading surfaces and a plurality of horn opening sides, each of the plurality of radiation spreading surfaces extends along a front-to-rear direction from a corresponding one of the plurality of horn opening sides towards the throat, a center of the first mounting hole is on a reference plane, each of the plurality of radiation spreading surfaces has a centerline passing a midpoint of the corresponding one of the plurality of horn opening sides, an extension line of the centerline passes a center of the throat, the centerline of each of the plurality of radiation spreading surfaces has a projected length on the reference plane, and projected lengths of centerlines of the plurality of radiation spreading surfaces are different from each other. Through the asymmetric features of the radiation spreading surfaces, it is feasible to effectively adjust the sound tone produced by each tweeter, control the sound spreading mode, and change the areas covered by the directional output of sound.

In certain embodiments, the plurality of radiation spreading surfaces include a first radiation spreading surface, a second radiation spreading surface, a third radiation spreading surface and a fourth radiation spreading surface. The first radiation spreading surface extends along a front-to-rear direction from a first horn opening side towards the throat, and has a first centerline. The first centerline passes a midpoint of the first horn opening side and has a first projected length on the reference plane. An extension line of the first centerline passes the center of the throat. The second radiation spreading surface extends along a front-to-rear direction from a second horn opening side towards the throat, and has a second centerline. The second centerline passes a midpoint of the second horn opening side and has a second projected length on the reference plane. An extension line of the second centerline passes the center of the throat. The third radiation spreading surface extends along a front-to-rear direction from a third horn opening side towards the throat, and has a third centerline. The third centerline passes a midpoint of the third horn opening side and has a third projected length on the reference plane. An extension line of the third centerline passes the center of the throat. The fourth radiation spreading surface extends along a front-to-rear direction from a fourth horn opening side towards the throat, and has a fourth centerline. The fourth centerline passes a midpoint of the fourth horn opening side and has a fourth projected length on the reference plane. An extension line of the fourth centerline passes the center of the throat. The first projected length, the second projected length, the third projected length and the fourth projected length are different from each other.

In certain embodiments, the first radiation spreading surface and the second radiation spreading surface are opposite to each other, the first horn opening side is closer to the inner region, and the second horn opening side is closer to a rim of the speaker system housing; the third radiation spreading surface and the fourth radiation spreading surface are opposite to each other; two ends of the third horn opening side are connected to one end of the first horn opening side and one end of the second horn opening side, respectively; and two ends of the fourth horn opening side are connected to the other end of the first horn opening side and the other end of the second horn opening side, respectively.

In certain embodiments, the first projected length is less than the second projected length.

In certain embodiments, the at least one waveguide horn includes a plurality of waveguide horns; and for each two adjacent ones of the plurality of waveguide horns, the third radiation spreading surface of one of the each two adjacent waveguide horns corresponds to the fourth radiation spreading surface of the other one of the each two adjacent waveguide horns, and the third projected length of the one of the each two adjacent waveguide horns is greater than the fourth projected length of the other one of the each two adjacent waveguide horns.

In certain embodiments, the at least one waveguide horn includes a plurality of waveguide horns, and the plurality of waveguide horns have the same shape and configuration.

In certain embodiments, the at least one waveguide horn includes a plurality of waveguide horns, and the plurality of waveguide horns have different shapes and different configurations from each other.

In certain embodiments, the first horn opening side and the second horn opening side are circularly curved.

In certain embodiments, the speaker system housing includes a front cover and a rear cover. The front cover is provided with the first mounting hole, the at least one waveguide horn and the second mounting hole of each of the at least one waveguide horn. The rear cover is mountable with the front cover, and a reflective chamber is formed by at least one of the front cover and rear cover.

Certain aspects of the present disclosure are directed to a front cover with one or more waveguide horns having one or more asymmetric radiation structures. The front cover is applicable to a speaker system housing and has a first mounting hole, at least one waveguide horn, and at least one second mounting hole. The first mounting hole is for mounting a woofer therein and located at an inner region of the front side of the front cover. The at least one waveguide horn is provided at an outer region of the front side of the front cover. The at least one second mounting hole is for mounting at least one tweeter therein and provided at a throat of the at least one waveguide horn. Each of the at least one waveguide horn has a plurality of radiation spreading surfaces and a plurality of horn opening sides, each of the plurality of radiation spreading surfaces extends along a front-to-rear direction from a corresponding one of the plurality of horn opening sides towards the throat, a center of the first mounting hole is on a reference plane, each of the plurality of radiation spreading surfaces has a centerline passing a midpoint of the corresponding one of the plurality of horn opening sides, an extension line of the centerline passes a center of the throat, the centerline of each of the plurality of radiation spreading surfaces has a projected length on the reference plane, and projected lengths of centerlines of the plurality of radiation spreading surfaces are different from each other.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective view of a speaker system according to certain embodiments of the present disclosure.

FIG. 2 is a front view of a speaker system according to certain embodiments of the present disclosure.

FIG. 3 is an exploded view of a speaker system according to certain embodiments of the present disclosure.

FIG. 4 is a perspective view of a front cover according to certain embodiments of the present disclosure.

FIG. 5A is a cross-section view of a first radiation spreading surface according to certain embodiments of the present disclosure.

FIG. 5B is a cross-section view of a second radiation spreading surface according to certain embodiments of the present disclosure.

FIG. 5C is a cross-section view of a third radiation spreading surface according to certain embodiments of the present disclosure.

FIG. 5D is a cross-section view of a fourth radiation spreading surface according to certain embodiments of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the term “and/or” includes any and all combinations of one or more of the associated listed items. Titles or subtitles can be used herein for the convenience of a reader, which shall have no influence on the scope of the present disclosure.

The accompanying drawings are schematic and may not have been drawn to scale. The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, materials, objects, or the like, which are for distinguishing one component/material/object from another one only, and are not intended to, nor should be construed to impose any substantive limitations on the components, materials, objects, or the like. Directional terms (e.g., “front”, “rear”, “left”, “right”, “upper/top” and/or “lower/bottom”) are explanatory only and are not intended to be restrictive of the scope of the present disclosure.

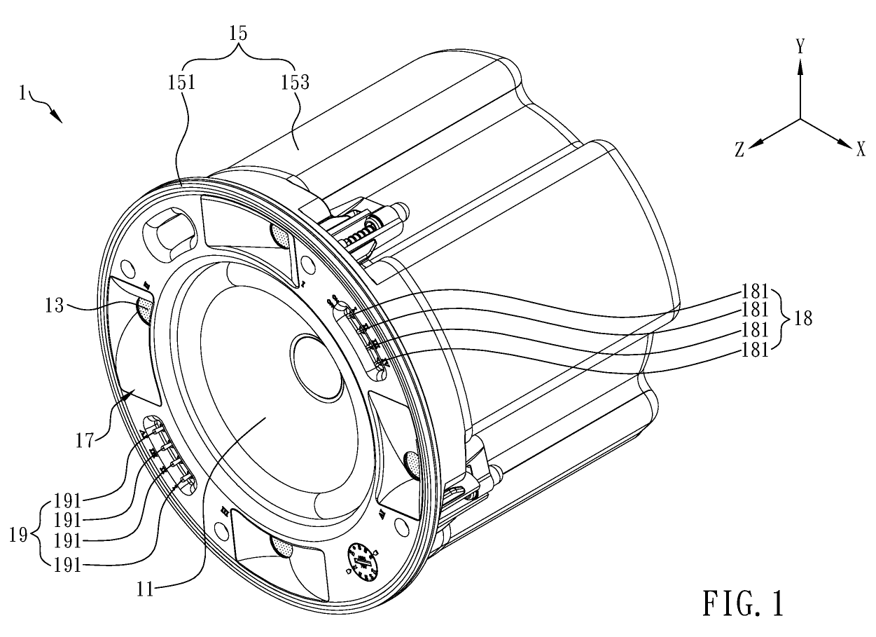

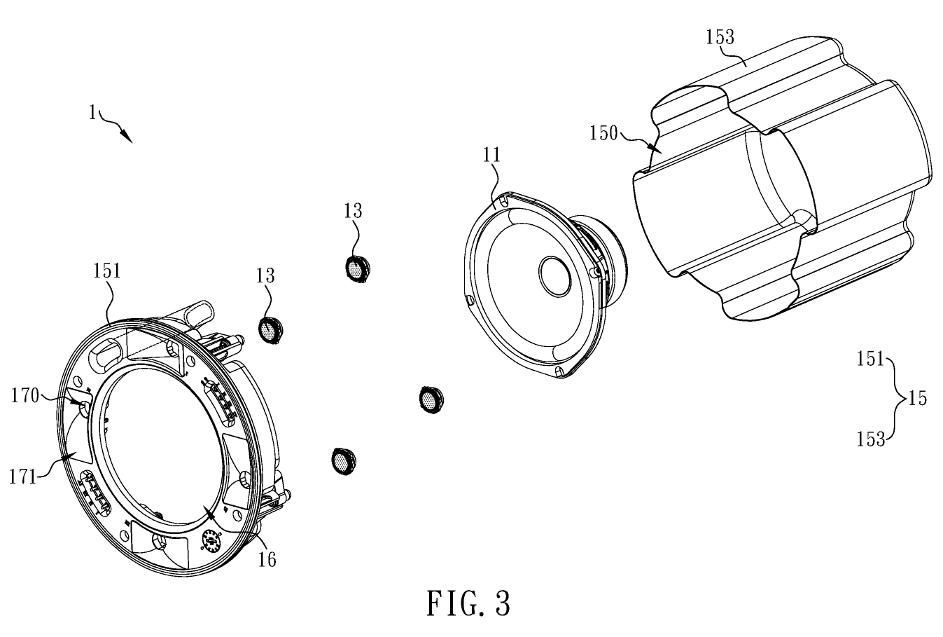

Certain aspects of the present disclosure are directed to a speaker system with waveguide horns having asymmetric radiation structures, and the front cover thereof. Referring to FIG. 1 to FIG. 3, in certain embodiments, the speaker system 1 includes a bass speaker (that is, a woofer) 11; a plurality of tweeters 13; and a speaker system housing 15. However, in certain embodiments, based on product demands, the number of the tweeter(s) 13 can be one. To facilitate description of element features and relative positional relationship, the spatial configuration of the elements as used in the present disclosure is defined by three axes that are perpendicular to one another, namely a transverse axis (the X axis), a longitudinal axis (the Y axis), and a depth axis (the Z axis). The transverse axis (the X axis) refers to a direction that extends between the right side and the left side, wherein the upper left corner of FIG. 1 is defined as a position on the left side of an element, the lower right corner of FIG. 1 is defined as a position on the right side of an element; the longitudinal axis (the Y axis) refers to a direction that extends between the top side and the bottom side, wherein the top edge of FIG. 1 is defined as a position on the upper side (the top side) of an element, and the bottom edge of FIG. 1 is defined as a position on the lower side (the bottom side) of an element. The depth axis (the Z axis) refers to a direction that extends between the front side and the rear side, wherein the lower left corner of FIG. 1 is defined as a position in front of an element, and the upper right corner of FIG. 1 is defined as a position behind an element.

With continued reference to FIG. 1 to FIG. 3, the woofer 11 is responsible for producing low-frequency sound effects and has a frequency response range generally from 20 Hz to 1 KHz. The tweeters 13 are responsible for producing high-frequency sound effects and have a frequency response range generally from 1 KHz to 20 KHz. The specific structures of the woofer 11 and tweeters 13 can include elements such as one or more voice coils, one or more magnets, one or more cones, etc., and as long as a speaker driver can produce the low-frequency sound effects or the high-frequency sound effects, it falls within the scope of the woofer 11 or tweeter 13 in the present disclosure.

With continued reference to FIG. 1 to FIG. 3, the front side of the speaker system housing 15 can be divided into an inner region and an outer region. The inner region is close to the front central portion of the speaker system housing 15 and is provided with a first mounting hole 16, and the first mounting hole 16 is where the woofer 11 can be mounted. The outer region is located on the outside of the inner region, is generally close to the rim of the speaker system housing 15, and is provided with a plurality of waveguide horns 17. Each waveguide horn 17 has a three-dimensional configuration that is gradually reduced in size in a front-to-rear direction. The front end of each waveguide horn 17 is a horn opening and is the widest area of the entire waveguide horn 17. The rear end of each waveguide horn 17 is a throat and is the narrowest area of the entire waveguide horn 17. The throat of each waveguide horn 17 is provided with a second mounting hole 170 where a corresponding tweeter 13 can be mounted. However, based on the number of the tweeter(s) 13, the number of the second mounting hole(s) 170 can also be one.

With continued reference to FIG. 1 to FIG. 3, in certain embodiments, the speaker system housing 15 includes a front cover 151 and a rear cover 153. Each of the front cover 151 and the rear cover 153 can be a single element or include plural elements. The front cover 151 can be provided with the first mounting hole 16, waveguide horns 17 and the second mounting hole(s) 170, and can be mounted at a position on the front side of the rear cover 153. The rear cover 153 is provided therein with a reflective chamber 150, and the reflective chamber 150 is configured to control the reflection and spreading of acoustic waves and to thereby enhance low-frequency resonance and optimize low-frequency sound performance. In certain embodiments, the speaker system housing 15 is a single element or includes plural elements, and is not limited to the structure of the front cover 151 and the rear cover 153 described supra. In certain embodiments, the speaker system housing 15 may be composed only of the front cover 151, and in that case, the required reflective chamber 150 is formed by mounting the front cover 151 in an external environment. For example, when the speaker system 1 adopts a ceiling-mounted architecture, the speaker system housing 15 (that is, the front cover 151) may be mounted in an opening in a ceiling, with the speaker system housing 15 (that is, the front cover 151) and the space inside the ceiling jointly forming the reflective chamber 150. In certain embodiments, the reflective chamber 150 can be disposed entirely within the front cover 151, or only a part of the reflective chamber 150 is disposed within the front cover 151 with the rest of the reflective chamber 150 being in the rear cover 153. In other words, there is no particular limitation to the specific structure of the reflective chamber 150, and as long as a reflective chamber is located in the front cover 151 and/or the rear cover 153, or between the front cover 151 and the rear cover 153, or together with an external environment can provide required acoustics properties, it is the reflective chamber 150 in the present disclosure.

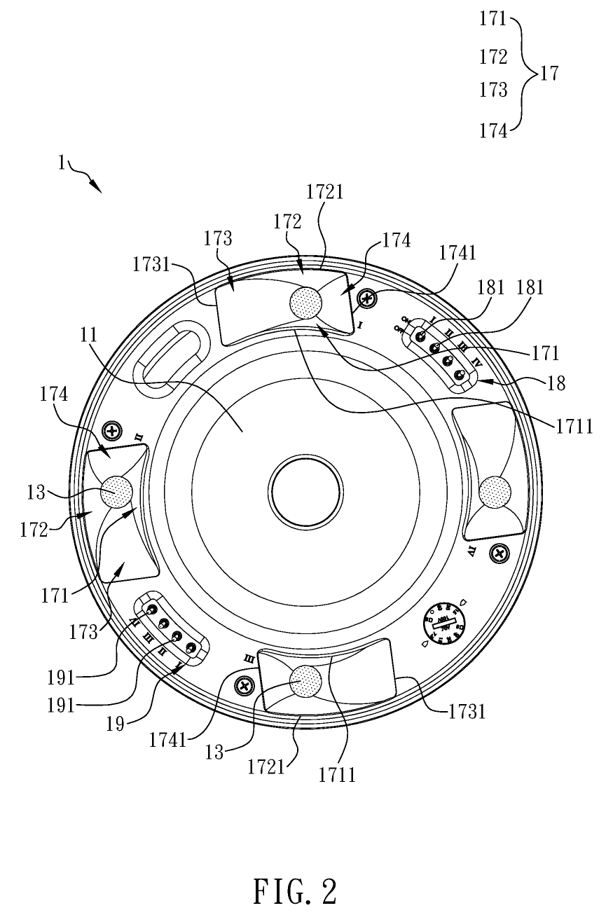

Referring to FIG. 2, in certain embodiments, the speaker system housing 15 is provided with four waveguide horns 17. All the waveguide horns 17 have the same shape and configuration, and can be annularly provided at the outer region and spaced apart from each other by the same distance. However, the present disclosure is not limited thereto. In certain embodiments, the speaker system housing 15 can be provided with two or more waveguide horns 17. In certain embodiments, the waveguide horns 17 of the speaker system housing 15 can all have different shapes and/or configurations. In certain embodiments, some of the waveguide horns 17 have the same shape and configuration, while the other waveguide horn(s) 17 has a different shape and/or configuration. In certain embodiments, the distance between each two waveguide horns 17 can vary. Accordingly, based on actual product needs, the configuration, number and location of each waveguide horn can be adjusted flexibly.

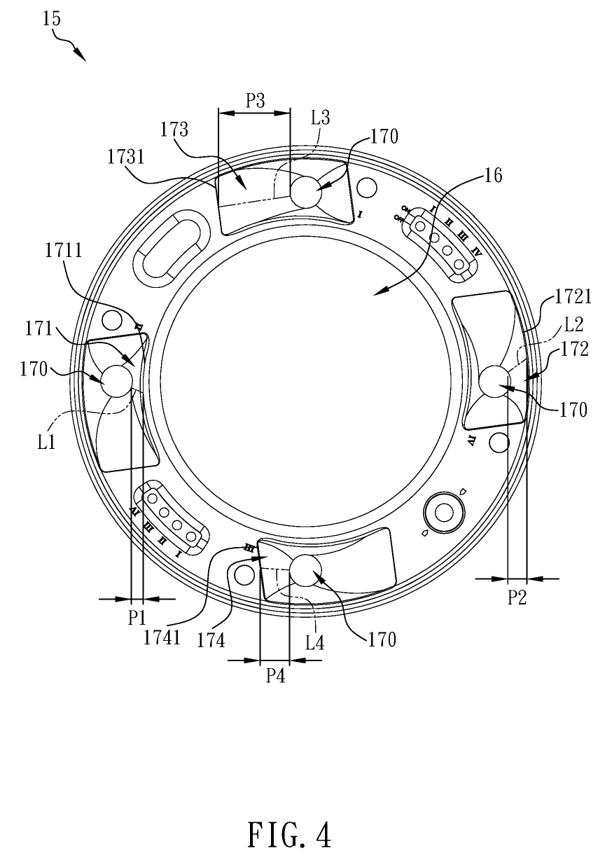

Referring to FIG. 2 and FIG. 4, in certain embodiments, the waveguide horns 17 have the same shape and configuration, and each waveguide horn 17 is formed of four radiation spreading surfaces in a surrounding arrangement, namely, a first radiation spreading surface 171, a second radiation spreading surface 172, a third radiation spreading surface 173 and a fourth radiation spreading surface 174. The first radiation spreading surface 171 and the second radiation spreading surface 172 are opposite to each other, and the third radiation spreading surface 173 and the fourth radiation spreading surface 174 are opposite to each other. Accordingly, the horn opening of a waveguide horn 17 is formed by a first horn opening side 1711, a second horn opening side 1721, a third horn opening side 1731, and a fourth horn opening side 1741 that are connected to each other. The first horn opening side 1711 is closer to the inner region (that is, closer to the first mounting hole 16); the second horn opening side 1721 is closer to the rim of the speaker system housing 15 (that is, away from the first mounting hole 16); two ends of the third horn opening side 1731 are connected to one end of the first horn opening side 1711 and one end of the second horn opening side 1721, respectively; and two ends of the fourth horn opening side 1741 are connected to the other end of the first horn opening side 1711 and the other end of the second horn opening side 1721, respectively.

Referring again to FIGS. 2 and 4, the first radiation spreading surface 171 extends along a direction from the first horn opening side 1711 towards the throat (that is, a direction towards the second mounting hole 170). The first radiation spreading surface 171 has a first centerline L1, the first centerline L1 passes the midpoint of the first horn opening side 1711, and the extension line of the first centerline L1 passes the center of the throat. The second radiation spreading surface 172 extends along a direction from the second horn opening side 1721 towards the throat (that is, the direction towards the second mounting hole 170). The second radiation spreading surface 172 has a second centerline L2, the second centerline L2 passes the midpoint of the second horn opening side 1721, and the extension line of the second centerline L2 passes the center of the throat. The third radiation spreading surface 173 extends along a direction from the third horn opening side 1731 towards the throat (that is, the direction towards the second mounting hole 170). The third radiation spreading surface 173 has a third centerline L3, the third centerline L3 passes the midpoint of the third horn opening side 1731, and the extension line of the third centerline L3 passes the center of the throat. The fourth radiation spreading surface 174 extends along a direction from the fourth horn opening side 1741 towards the throat (that is, the direction towards the second mounting hole 170). The fourth radiation spreading surface 174 has a fourth centerline L4, the fourth centerline L4 passes the midpoint of the fourth horn opening side 1741, and the extension line of the fourth centerline L4 passes the center of the throat.

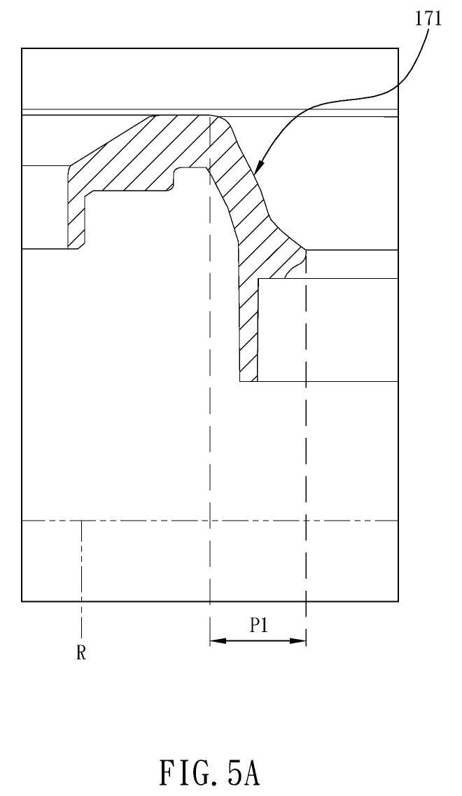

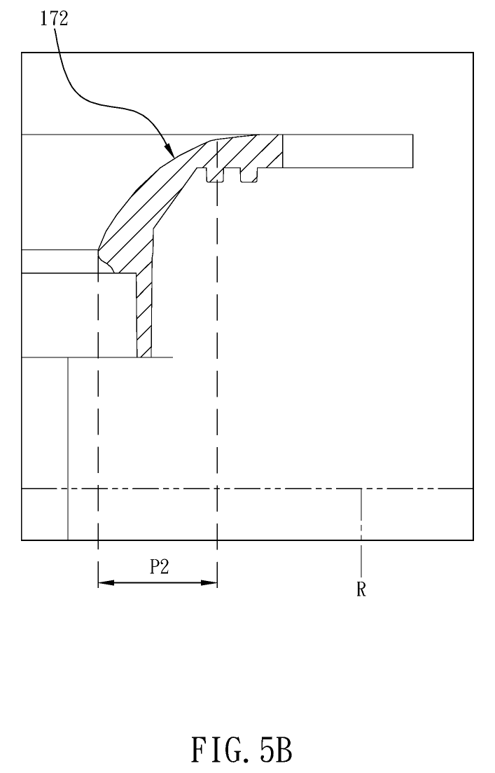

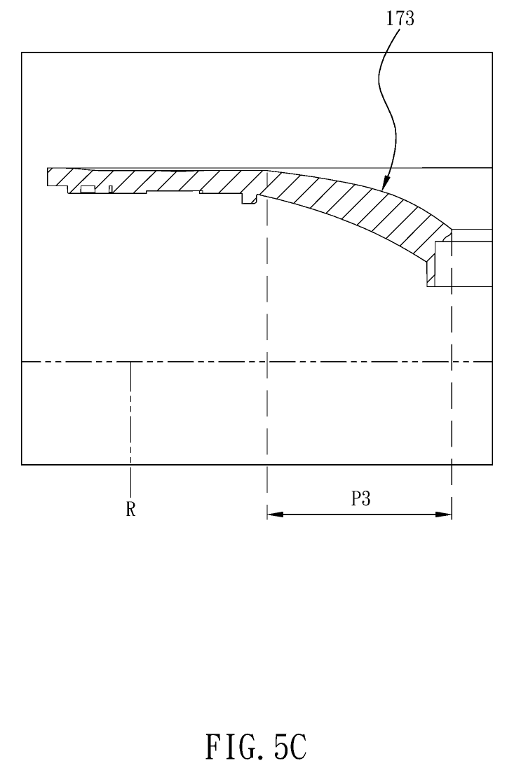

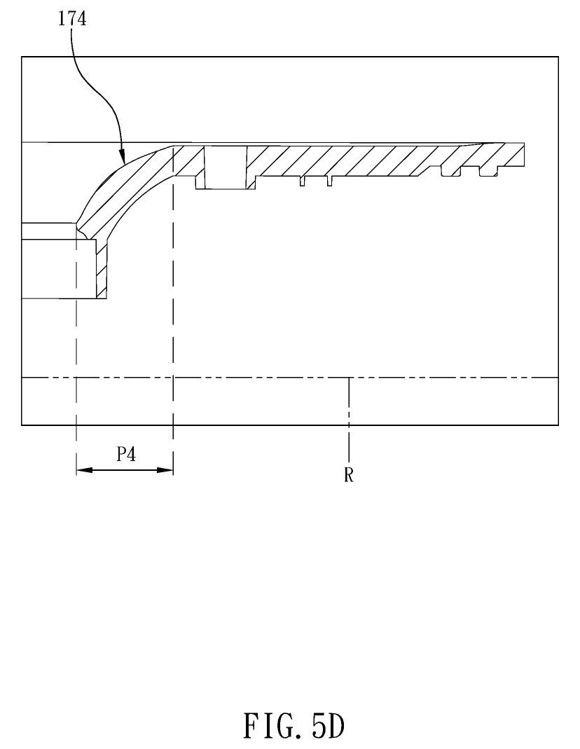

Referring to FIG. 4 and FIG. 5A to FIG. 5D, an imaginary plane defined based on the center point of the first mounting hole 16, the transverse axis (the X axis) and the longitudinal axis (the Y axis) is used as a reference plane R, and the reference plane R is located in a coordinate plane defined by the transverse axis (the X axis) and the longitudinal axis (the Y axis). The reference plane R can be moved in the drawings as needed to make it easy to mark the projected lengths mentioned below, and this change in position of the reference plane R serves only to meet the need to mark the projected lengths in the drawings and does not affect the definition of the reference plane R. Referring to FIG. 5A, the first centerline L1 of the first radiation spreading surface 171 has a first projected length P1 on the reference plane R. Referring to FIG. 5B, the second centerline L2 of the second radiation spreading surface 172 has a second projected length P2 on the reference plane R. Referring to FIG. 5C, the third centerline L3 of the third radiation spreading surface 173 has a third projected length P3 on the reference plane R. Referring to FIG. 5D, the fourth centerline L4 of the fourth radiation spreading surface 174 has a fourth projected length P4 on the reference plane R. In certain embodiments, the respective lengths of the first projected length P1, the second projected length P2, the third projected length P3 and the fourth projected length P4 are different from each other.

Referring to FIG. 1 to FIG. 4, when the speaker system 1 is exemplarily provided in a ceiling (i.e., when a ceiling-mounted architecture is adopted), the multiple radiation spreading surfaces of the asymmetric structure of each waveguide horn 17 can produce a better auditory effect by adjusting the radiation angle of high-frequency sound, which has a significant off-axis response (i.e., high directivity); preventing audio frequencies from being overly concentrated or overly diffuse; and thus effectively modifying the directivity and tone of the sound produced. In certain embodiments, the first projected length P1 can be less than the second projected length P2. A shorter first projected length P1 indicates that the corresponding first radiation spreading surface 171 is steeper, and such a configuration can increase the crossover distances between the frequencies of high-frequency sounds, and reduce the mutual interference between two diametrically opposite tweeters 13 (e.g., the uppermost tweeter 13 and the lowest tweeter 13 in FIG. 2). A longer second projected length P2 indicates that the corresponding second radiation spreading surface 172 has a gentler slope (i.e., is leveler), and since the radiation direction of each second radiation spreading surface 172 expands outward, such a configuration can enhance the scattering and spreading of acoustic waves, and enlarge the areas covered by the radiation of the tweeters 13. In certain embodiments, the first horn opening side 1711 and the second horn opening side 1721 of each waveguide horn 17 can be circularly curved (however, the present disclosure is not limited thereto), such that the horn opening of each waveguide horn 17 is circularly curved along the periphery of the woofer 11, and such a configuration contributes to an even distribution of acoustic waves in space, can reduce over-concentration and over-diffusion of acoustic energy, and with the circularly curved horn openings being effective in reducing phase interference caused by acoustic wave reflections, can improve the stability of the acoustic field created and the clarity of the sound produced.

Referring to FIGS. 1-4, the speaker system 1 is annularly provided with a plurality of waveguide horns 17. Each two adjacent waveguide horns 17 are arranged in such a way that, taking the uppermost waveguide horn 17 and the leftmost waveguide horn 17 in FIG. 2 for example, the third radiation spreading surface 173 of the uppermost waveguide horn 17 corresponds to the fourth radiation spreading surface 174 of the leftmost waveguide horn 17. The third projected length P3 of the third radiation spreading surface 173 is greater than the fourth projected length P4 of the fourth radiation spreading surface 174. Accordingly, these corresponding radiation spreading surfaces of the two adjacent waveguide horns 17 have different geometric shapes: the third radiation spreading surface 173 has a relatively gently sloped configuration whereas the fourth radiation spreading surface 174 has a relatively steep configuration. This not only can effectively reduce mutual interference between two tweeters 13, but also helps with the clarity and directivity of the sound effects produced. In addition, the smoothness of high-frequency sound and the harmony and consistency of the acoustic field of the speaker system 1 can be further optimized by the corresponding yet differently shaped radiation spreading surfaces of each two adjacent waveguide horns 17 (for example, the third radiation spreading surface 173 and the fourth radiation spreading surface 174). The term “correspond” as used above refers generally to an association in position and direction between two waveguide horns 17 that are sequentially arranged in and along the outer region; therefore, the aforesaid corresponding third radiation spreading surface 173 and fourth radiation spreading surface 174 need not be arranged in such a way that they face each other directly. For example, when the waveguide horns 17 are annularly arranged in and along the outer region at the 3-o’clock, 6-o’clock, 9-o’clock, and 12-o’clock positions, the waveguide horns 17 at the 12-o’clock and 9-o’clock positions are adjacent to each other, and the adjacent third radiation spreading surface 173 and fourth radiation spreading surface 174 that belong separately to these two adjacent waveguide horns 17 correspond to each other.

Depending on the site and position where the speaker system 1 is mounted and individual listeners’ needs, it is not necessarily required to have all the tweeters 13 operate (i.e., produce sound) at the same time in actual use. Therefore, referring to FIG. 1 to FIG. 3, the speaker system 1 is further provided with a high-frequency sound on/off control portion 18 that includes a plurality of high-frequency sound control switches 181. Each of the high-frequency sound control switches 181 is connected to a tweeter 13 that is not connected to the other high-frequency sound control switch(es) 181, and can independently control the turning on or off of the tweeter 13. Accordingly, a user can based on actual needs chooses by himself or herself to turn on or off any number of the tweeters 13, adjust the distribution properties of the acoustic field created and change of the areas covered by the directional output of sound from the speaker system 1 so as to reduce unnecessary high-frequency acoustic wave interference and to further enhance the clarity of the acoustic field and the precision of the sound effects produced.

Moreover, a sound is a composite wave formed by a superposition of waves of multiple frequencies, with the lowest frequency in the composite wave being referred to as the fundamental frequency. The fundamental-frequency portion of a composite wave (i.e., acoustic wave) is the portion that has the highest energy and that determines the pitch of the acoustic wave, and the portion of the acoustic wave that is other than the fundamental-frequency portion is called the overtones, the frequency of each of overtones is generally an integer number of times as high as the fundamental frequency. The sounds of different sounding bodies have distinctive tones because of their different overtone distributions/ratios, which constitute a key factor contributing to the quality of sound. Accordingly, referring to FIGS. 1-3, in certain embodiments, the speaker system 1 is further provided with a tone adjustment portion 19 that includes a plurality of tone control switches 191. Each of the tone control switches 191 is connected to a tweeter 13 that is not connected to the other tone control switch(es) 191, and can independently control the frequency range of the tweeter 13. For example, the frequency ranges of the four tweeters 13 can be set to 2500Hz, 5000Hz, 10000Hz and 2500Hz, respectively. Accordingly, a user can based on actual needs adjust by himself or herself the frequency range of each tweeter 13, thereby changing the fundamental frequencies and overtone distributions of the tweeters 13 so that the tone of the sound produced can be fine-tuned to satisfy the listening needs in various scenarios and to cater for individual listeners’ preferences in tone.

Referring again to FIGS. 1-3, characterized by asymmetry in shape, angle, and extending direction and inequality in length, the multiple radiation spreading surfaces of the waveguide horns 17 can effectively adjust the tone of the sound produced by the tweeters 13, control the sound spreading mode, and thereby change the areas covered by the directional output of sound. However, in certain embodiments, based on actual product needs, the number of the radiation spreading surfaces of a waveguide horn 17 is not limited to four, and can be any number greater than 1, as long as the projected lengths of such radiation spreading surfaces are different from each other. In certain embodiments, the waveguide horns 17 are integrally formed with the front cover 151. However, the present disclosure is not limited thereto. In certain embodiments, one or more waveguide horns 17 can be independent elements, and one or more assembling holes can be provided on the front cover 151 for mounting the one or more waveguide horns 17. Accordingly, based on user needs as well as the type of the speaker system 1 and the site and position where the speaker system 1 is mounted, waveguide horns 17 of different shapes/configurations can be conveniently replaced to meet different sound effect requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A speaker system, comprising:
a woofer;
at least one tweeter; and
a speaker system housing having a front side divided into an inner region and an outer region, wherein the inner region is provided with a first mounting hole for mounting the woofer therein, the outer region is provided with at least one waveguide horn, and a throat of each of the at least one waveguide horn is provided with a second mounting hole for mounting a corresponding one of the at least one tweeter therein,
wherein each of the at least one waveguide horn has a plurality of radiation spreading surfaces and a plurality of horn opening sides, each of the plurality of radiation spreading surfaces extends along a front-to-rear direction from a corresponding one of the plurality of horn opening sides towards the throat, a center of the first mounting hole is on a reference plane, each of the plurality of radiation spreading surfaces has a centerline passing a midpoint of the corresponding one of the plurality of horn opening sides, an extension line of the centerline passes a center of the throat, the centerline of each of the plurality of radiation spreading surfaces has a projected length on the reference plane, and projected lengths of centerlines of the plurality of radiation spreading surfaces are different from each other.

2. The speaker system according to claim 1, wherein the plurality of radiation spreading surfaces include:
a first radiation spreading surface extending along a front-to-rear direction from a first horn opening side towards the throat, and having a first centerline passing a midpoint of the first horn opening side and having a first projected length on the reference plane, wherein an extension line of the first centerline passes the center of the throat;
a second radiation spreading surface extending along a front-to-rear direction from a second horn opening side towards the throat, and having a second centerline passing a midpoint of the second horn opening side and having a second projected length on the reference plane, wherein an extension line of the second centerline passes the center of the throat;
a third radiation spreading surface extending along a front-to-rear direction from a third horn opening side towards the throat, and having a third centerline passing a midpoint of the third horn opening side and having a third projected length on the reference plane, wherein an extension line of the third centerline passes the center of the throat; and
a fourth radiation spreading surface extending along a front-to-rear direction from a fourth horn opening side towards the throat, and having a fourth centerline passing a midpoint of the fourth horn opening side and having a fourth projected length on the reference plane, wherein an extension line of the fourth centerline passes the center of the throat,
wherein the first projected length, the second projected length, the third projected length and the fourth projected length are different from each other.

3. The speaker system according to claim 2, wherein the first radiation spreading surface and the second radiation spreading surface are opposite to each other, the first horn opening side is closer to the inner region, and the second horn opening side is closer to a rim of the speaker system housing; the third radiation spreading surface and the fourth radiation spreading surface are opposite to each other; two ends of the third horn opening side are connected to one end of the first horn opening side and one end of the second horn opening side, respectively; and two ends of the fourth horn opening side are connected to the other end of the first horn opening side and the other end of the second horn opening side, respectively.

4. The speaker system according to claim 2, wherein the first projected length is less than the second projected length.

5. The speaker system according to claim 2, wherein the at least one waveguide horn includes a plurality of waveguide horns; and for each two adjacent ones of the plurality of waveguide horns, the third radiation spreading surface of one of the each two adjacent waveguide horns corresponds to the fourth radiation spreading surface of the other one of the each two adjacent waveguide horns, and the third projected length of the one of the each two adjacent waveguide horns is greater than the fourth projected length of the other one of the each two adjacent waveguide horns.

6. The speaker system according to claim 1, wherein the at least one waveguide horn includes a plurality of waveguide horns, and the plurality of waveguide horns have the same shape and configuration.

7. The speaker system according to claim 1, wherein the at least one waveguide horn includes a plurality of waveguide horns, and the plurality of waveguide horns have different shapes and different configurations from each other.

8. The speaker system according to claim 2, wherein the first horn opening side and the second horn opening side are circularly curved.

9. The speaker system according to claim 1, wherein the speaker system housing includes:
a front cover provided with the first mounting hole, the at least one waveguide horn and the second mounting hole of each of the at least one waveguide horn; and
a rear cover mountable with the front cover, wherein a reflective chamber is formed by at least one of the front cover and rear cover.

10. A front cover applicable to a speaker system housing and having:
a first mounting hole for mounting a woofer therein and located at an inner region of a front side of the front cover;
at least one waveguide horn provided at an outer region of the front side of the front cover; and
at least one second mounting hole for mounting at least one tweeter therein and provided at a throat of the at least one waveguide horn,
wherein each of the at least one waveguide horn has a plurality of radiation spreading surfaces and a plurality of horn opening sides, each of the plurality of radiation spreading surfaces extends along a front-to-rear direction from a corresponding one of the plurality of horn opening sides towards the throat, a center of the first mounting hole is on a reference plane, each of the plurality of radiation spreading surfaces has a centerline passing a midpoint of the corresponding one of the plurality of horn opening sides, an extension line of the centerline passes a center of the throat, the centerline of each of the plurality of radiation spreading surfaces has a projected length on the reference plane, and projected lengths of centerlines of the plurality of radiation spreading surfaces are different from each other.

11. The front cover according to claim 10, wherein the plurality of radiation spreading surfaces include:
a first radiation spreading surface extending along a front-to-rear direction from a first horn opening side towards the throat, and having a first centerline passing a midpoint of the first horn opening side and having a first projected length on the reference plane, wherein an extension line of the first centerline passes the center of the throat;
a second radiation spreading surface extending along a front-to-rear direction from a second horn opening side towards the throat, and having a second centerline passing a midpoint of the second horn opening side and having a second projected length on the reference plane, wherein an extension line of the second centerline passes the center of the throat;
a third radiation spreading surface extending along a front-to-rear direction from a third horn opening side towards the throat, and having a third centerline passing a midpoint of the third horn opening side and having a third projected length on the reference plane, wherein an extension line of the third centerline passes the center of the throat; and
a fourth radiation spreading surface extending along a front-to-rear direction from a fourth horn opening side towards the throat, and having a fourth centerline passing a midpoint of the fourth horn opening side and having a fourth projected length on the reference plane, wherein an extension line of the fourth centerline passes the center of the throat,
wherein the first projected length, the second projected length, the third projected length and the fourth projected length are different from each other.

12. The front cover according to claim 11, wherein the first radiation spreading surface and the second radiation spreading surface are opposite to each other, the first horn opening side is closer to the inner region, and the second horn opening side is closer to a rim of the speaker system housing; the third radiation spreading surface and the fourth radiation spreading surface are opposite to each other; two ends of the third horn opening side are connected to one end of the first horn opening side and one end of the second horn opening side, respectively; and two ends of the fourth horn opening side are connected to the other end of the first horn opening side and the other end of the second horn opening side, respectively.

13. The front cover according to claim 11, wherein the first projected length is less than the second projected length.

14. The front cover according to claim 11, wherein the at least one waveguide horn includes a plurality of waveguide horns; and for each two adjacent ones of the plurality of waveguide horns, the third radiation spreading surface of one of the each two adjacent waveguide horns corresponds to the fourth radiation spreading surface of the other one of the each two adjacent waveguide horns, and the third projected length of the one of the each two adjacent waveguide horns is greater than the fourth projected length of the other one of the each two adjacent waveguide horns.

15. The front cover according to claim 11, wherein the first horn opening side and the second horn opening side are circularly curved.

16. The front cover according to claim 10, wherein the at least one waveguide horn includes a plurality of waveguide horns, and the plurality of waveguide horns have the same shape and configuration.

17. The front cover according to claim 10, wherein the at least one waveguide horn includes a plurality of waveguide horns, and the plurality of waveguide horns have different shapes and different configurations from each other.
